(19) United States
(12) Patent Application Publication
(10) Pub. No.: US 2014/0172583 A1
(43) Pub. Date: Jun. 19, 2014

(54) METHODS AND SYSTEMS FOR DISPLAYING SPONSORED CONTENT FROM THIRD PARTY NETWORKS

(71) Applicant: YAHOO! INC., Sunnyvale, CA (US)

(72) Inventors: Sarah Sosiak, San Francisco, CA (US); Roger William Graves, San Francisco, CA (US)

(73) Assignee: YAHOO! INC., Sunnyvale, CA (US)

(21) Appl. No.: 13/713,617

(22) Filed: Dec. 13, 2012

(51) Int. Cl. G06Q 30/02; G06Q 50/00

(52) U.S. Cl. CPC G06Q 30/0273; G06Q 50/01
USPC 705/14.69

(57) ABSTRACT

Methods and systems for enabling advertisers to purchase sponsored content from third party networks (e.g., social networks), and displaying the sponsored content on websites on a different network are disclosed. The method includes enabling an advertiser to select sponsored content that is served to users on a first advertising network. The advertiser may be requested to pay a premium to a second advertising network to serve the sponsored content on a website which is part of the second advertising network. The advertiser may select the website and the second advertising network, and the sponsored content may be served to users on the advertiser selected website on the second advertising network.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

Currently, advertisers cannot re-use sponsored content from one network, and have it served in an advertising position on a website on another network. There is a need for improved techniques in increasing the amount of users who view an advertiser's content, and for increasing the amount of advertising inventory available to advertising networks.

### SUMMARY

Some embodiments of the invention provide systems and methods for displaying sponsored content from third party networks, such as social networks, on websites of a different network. An advertiser may be enabled to select sponsored content that is served to users on a social network. As used herein, sponsored content refers to, for example a sponsored story or post on Facebook®, a promoted Tweet® on Twitter®, etc. In one embodiment, an interface may be displayed to enable the advertiser to select the sponsored content.

The advertiser may be enabled to pay a premium to an advertising network to serve the sponsored content on a website which is part of the advertising network. For example, an advertiser may pay a premium to Yahoo for serving sponsored content from the social network, such as Facebook or Twitter on one of Yahoo's websites or portals. In one embodiment, an interface may be displayed to enable the advertiser to provide payment to the advertising network. Alternatively, or in addition to paying a premium to the advertising network, the advertiser may pay a premium to the social network in order to be able to display the sponsored content on the advertising network.

The advertiser may be enabled to select the website on which the advertiser would like the sponsored content to be displayed. For example, the advertiser may wish to display the sponsored content only on fashion related websites. In one embodiment, an interface may be displayed to enable the advertiser to select or specify one or more websites on which the advertiser would like the sponsored content to be displayed. In one embodiment, the advertiser may specify one or more criteria relating to the website(s) on which they would like the sponsored content to be displayed. For example, the advertiser may specify that the sponsored content should be displayed on websites including fashion related content or sports related content. As will be apparent to one of ordinary skill in the art, the advertiser may specify any number of behavioral or demographic targeting criteria relating to their target audience.

The sponsored content may be served to users on the advertiser selected website on the advertising network. Using the above example, the sponsored content may be served to users viewing Yahoo's fashion related websites. In one embodiment, the sponsored content may be transmitted from one or more server computers to a user's browser application for display in the browser application.

One or more display advertisements may be automatically selected based at least in part on the sponsored content. For example, one or more display advertisements, which are related to the sponsored content may be selected. In one embodiment, the selected display advertisement(s) may be from the same advertiser as the sponsored content. For example, a display advertisement from Toyota may be selected to be displayed along with a promoted Tweet if the promoted Tweet is also from Toyota. In other embodiments, the display advertisement may be selected based on any other criteria related to the sponsored content. In one embodiment, the display advertisement(s) may be selected by the advertising network. An advertiser may specify if the advertiser would like the advertising network to select one or more advertisements to be displayed along with the sponsored content. In other embodiments, the advertiser may select one or more advertisements to be displayed along with the sponsored content.

The one or more display advertisements may be served to users on the advertiser selected website on the advertising network. In one embodiment, the one or more display advertisements may be transmitted from one or more server computers to a user's browser application for display in the browser application.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 is an exemplary distributed computer system according to one embodiment of the invention;

FIG. 2 is an exemplary schematic diagram illustrating a client device according to one embodiment of the invention;

FIG. 3 is an exemplary flowchart diagram according to one embodiment of the invention;

FIG. 4 is an exemplary flowchart diagram according to one embodiment of the invention;

FIG. 5 is an exemplary flowchart diagram according to one embodiment of the invention; and

FIG. 6 is an exemplary screenshot diagram of a website according to one embodiment of the invention.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

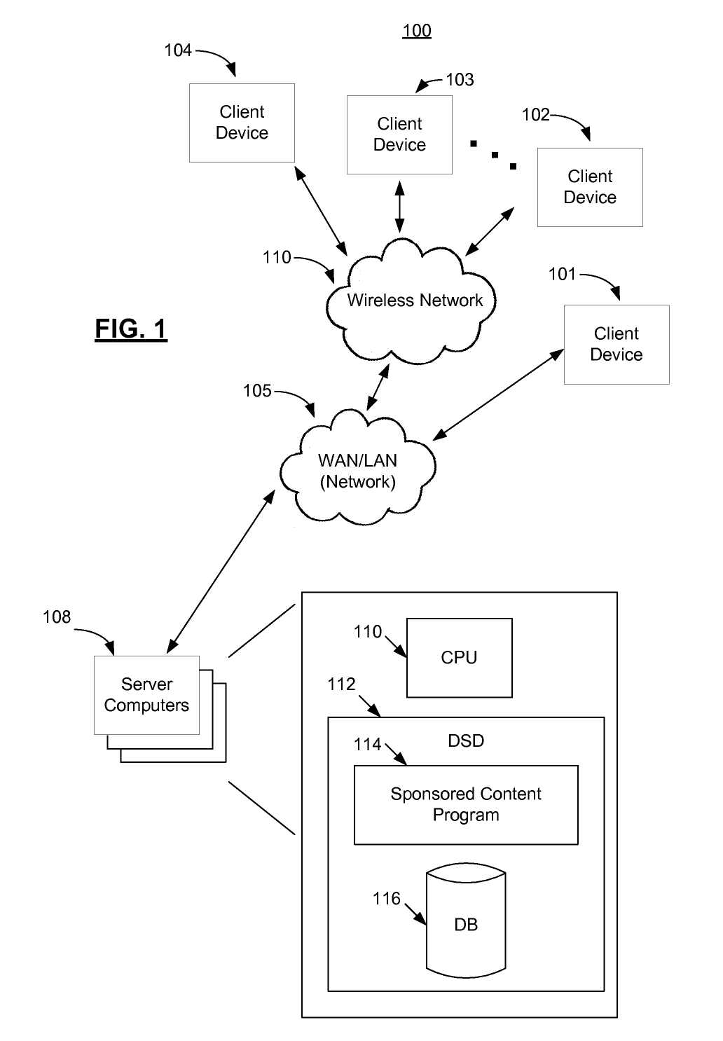

FIG. 1 is a schematic diagram illustrating one embodiment of an environment in which the invention may be practiced. Not all the components may be required to practice various embodiments, and variations in the arrangement and type of the components may be made. As shown, system 100 of FIG. 1 includes local area networks (“LANs”)/wide area networks (“WANs”)-(network) 105, wireless network 110, client devices 101-104, and server computer(s) 108.

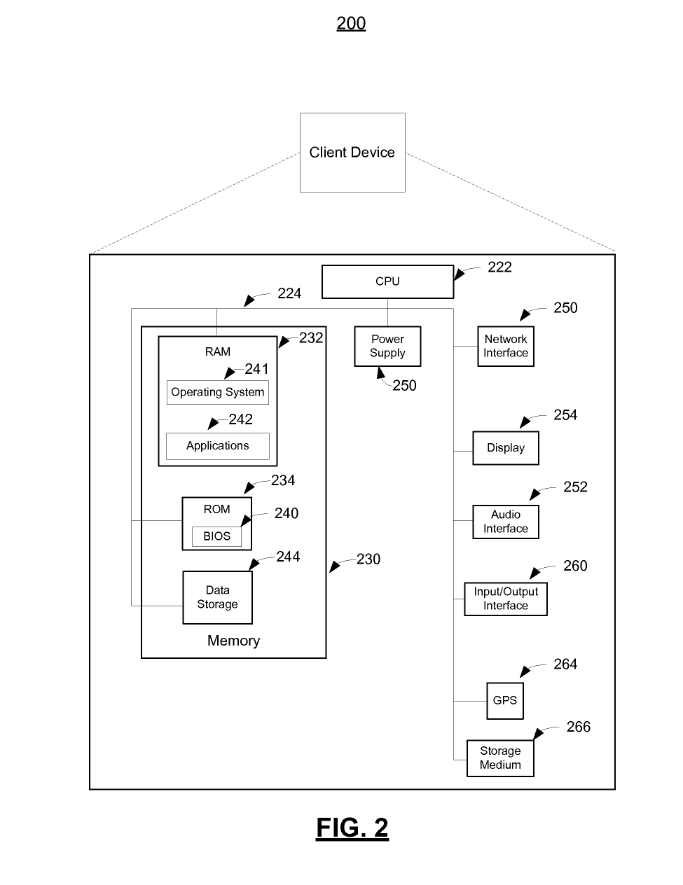

One embodiment of client devices 101-104 is described in more detail below in conjunction with FIG. 2. Generally, however, client devices 101-104 may include virtually any computing device capable of receiving and sending a message over a network, such as network 105, wireless network 110, or the like. Client devices 101-104 may also be described generally as client devices that are configured to be portable or mobile. Thus, client devices 101-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, e-readers, integrated devices combining one or more of the preceding devices, and the like. As such, client devices 101-104 typically range widely in terms of capabilities and features. For example, a cell phone may have a numeric keypad and a few lines of monochrome Liquid Crystal Display (LCD) on which only text may be displayed. In another example, a web-enabled mobile device may have a touch sensitive screen, a stylus, and several lines of color LCD in which both text and graphics may be displayed.

Client devices 101-104 may include devices that typically connect using a wired or wireless communications medium such as personal computers, multiprocessor systems, microprocessor-based or programmable consumer electronics, network Personal Computers (PCs), or the like. In one embodiment at least some of client devices 101-104 may operate over a wired and/or wireless network.

A client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like, to display and send a message. In one embodiment, a user of the client device may employ the browser application to perform various actions over a network (online). However, other applications may also be used to perform various online actions.

For example, client devices 101-104 also may include at least one other client application. The client application may include a capability to provide and receive textual content, graphical content, audio content, and the like. The client application may further provide information that identifies itself, including a type, capability, name, and the like. In one embodiment, client devices 101-104 may uniquely identify themselves through any of a variety of mechanisms, including a phone number, Mobile Identification Number (MIN), an electronic serial number (ESN), or other mobile device identifier. The information may also indicate a content format that the client device is enabled to employ. Such information may be provided in a network packet, or the like, sent between other client devices, server(s) 108, or other computing devices.

Wireless network 110 is configured to couple client devices 102-104 and its components with network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G), 5th (5G) generation radio access for cellular systems, WLAN, Wireless Router (WR) mesh, and the like. Access technologies such as 2G, 3G, 4G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple network devices with other computing devices, including, server(s) 108, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 105 and wireless network 110. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

Server(s) 108 may vary widely in configuration or capabilities, but generally a server may include a central processing unit 110 and memory (not shown). A server may also include a data storage device 114, one or more power supplies (not shown), one or more wired or wireless network interfaces (not shown), one or more input/output interfaces (not shown), or one or more operating systems (not shown), such as Windows Server, Mac OS X, Unix, Linux, FreeBSD, or the like. The data storage device 112 includes a database 116 and a Sponsored Content Program 114. The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices. Devices capable of operating as a server may include, as examples, dedicated rack-mounted servers, desktop computers, laptop computers, set top boxes, integrated devices combining various features, such as two or more features of the foregoing devices, or the like.

One or more of server(s) 108 may be configured as, for example a content server, search server, advertising server, etc. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

An “ad server” comprises a server that stores online advertisements for presentation to users. “Ad serving” refers to methods used to place online advertisements on websites, in applications, or other places where users are more likely to see them, such as during an online session or during computing platform use, for example.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so- called ‘virtual persons.’ An individual's social network may be represented in a variety of forms, such as visually, electronically or functionally. For example, a “social graph” or “socio-gram” may represent an entity in a social network as a node and a relationship as an edge or a link.

Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites (such as Facebook, Twitter, or Google+), or the like.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

FIG. 2 shows one embodiment of client device 200 that may be included in a system implementing the invention. Client device 200 may include more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, an input/output interface 260, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery. In one embodiment, although not shown, a gyroscope may be employed in client device 200 to measure and/or maintain an orientation of client device 200, and/or an orientation of a displayed image.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), Short Message Service (SMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand. In one embodiment, video interface 259 is configured to enable any of a variety of input/outputs for video digital data over a network.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth®, or the like. Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), Enhanced Observed Time Difference (E-OTD, Cell Identifier (CI), Service Area Identifier (SAI), Enhanced Timing Advance (ETA), Base Station Subsystem (BSS), or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a Media Access Control (MAC) address, IP address, or the like.

Mass memory 230 includes a RAM 232, a ROM 234, and data storage 244. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The memory also stores an operating system 241 for controlling the operation of client device 200. The client device may include or may execute a variety of operating systems, including a personal computer operating system, such as a Windows, iOS or Linux, or a mobile operating system, such as iOS, Android, or Windows Mobile, or the like.

Mass memory 230 further includes one or more data storage 244, which can be utilized by client device 200 to store, among other things, applications, software libraries, and/or other data. For example, data storage 244 may also be employed to store information that describes various capabilities of mobile device 200. The information may then be provided to another device, including being sent as part of a header during a communication, sent upon request, or the like. At least a portion of the data stored on data storage 244 may also be stored on storage medium 266, such as a disk drive, removable storage, or the like within client device 200.

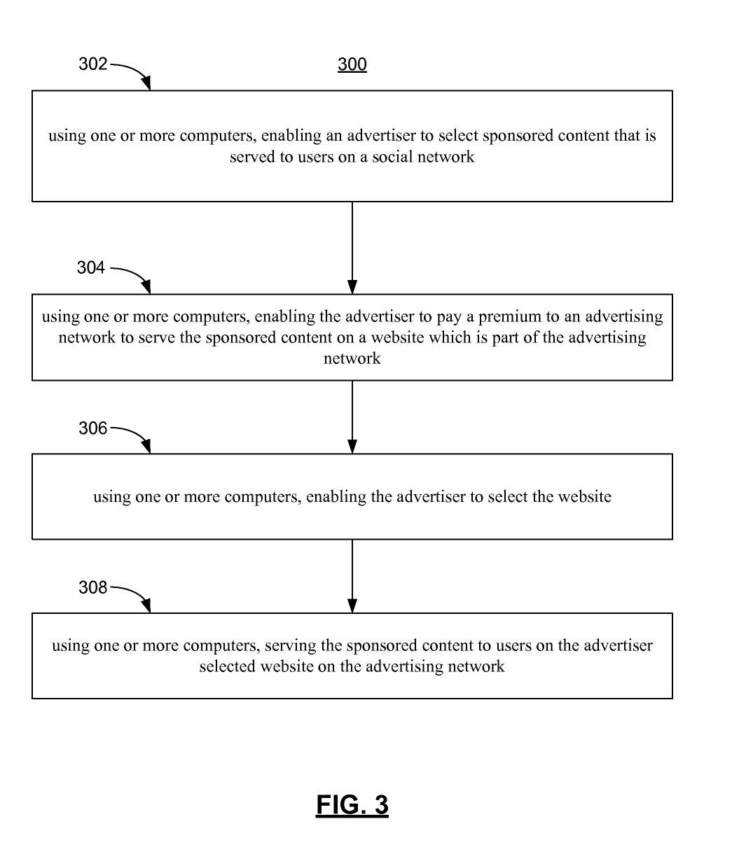

FIG. 3 is a flowchart diagram illustrating a method 300 according to one embodiment of the invention. At step 302, using one or more computers, an advertiser may be enabled to select sponsored content that is served to users on a social network. As used herein, sponsored content refers to, for example a sponsored story or post on Facebook®, a promoted Tweet® on Twitter®, etc. In one embodiment, an interface may be displayed to enable the advertiser to select the sponsored content.

At step 304, using one or more computers, the advertiser may be enabled to pay a premium to an advertising network to serve the sponsored content on a website which is part of the advertising network. For example, an advertiser may pay a premium to Yahoo for serving sponsored content from the social network, such as Facebook or Twitter on one of Yahoo's websites or portals. In one embodiment, an interface may be displayed to enable the advertiser to provide payment to the advertising network. Alternatively, or in addition to paying a premium to the advertising network, the advertiser may pay a premium to the social network in order to be able to display the sponsored content on the advertising network.

At step 306, using one or more computers, the advertiser may be enabled to select the website on which the advertiser would like the sponsored content to be displayed. For example, the advertiser may wish to display the sponsored content only on fashion related websites. In one embodiment, an interface may be displayed to enable the advertiser to select or specify one or more websites on which the advertiser would like the sponsored content to be displayed. In one embodiment, the advertiser may specify one or more criteria relating to the website(s) on which they would like the sponsored content to be displayed. For example, the advertiser may specify that the sponsored content should be displayed on websites including fashion related content or sports related content. As will be apparent to one of ordinary skill in the art, the advertiser may specify any number of behavioral, demographic, or keyword targeting criteria relating to their target audience.

At step 308, using one or more computers, the sponsored content may be served to users on the advertiser selected website on the advertising network. Using the above example, the sponsored content may be served to users viewing Yahoo's fashion related websites. In one embodiment, the sponsored content may be transmitted from one or more server computers to a user's browser application for display in the browser application.

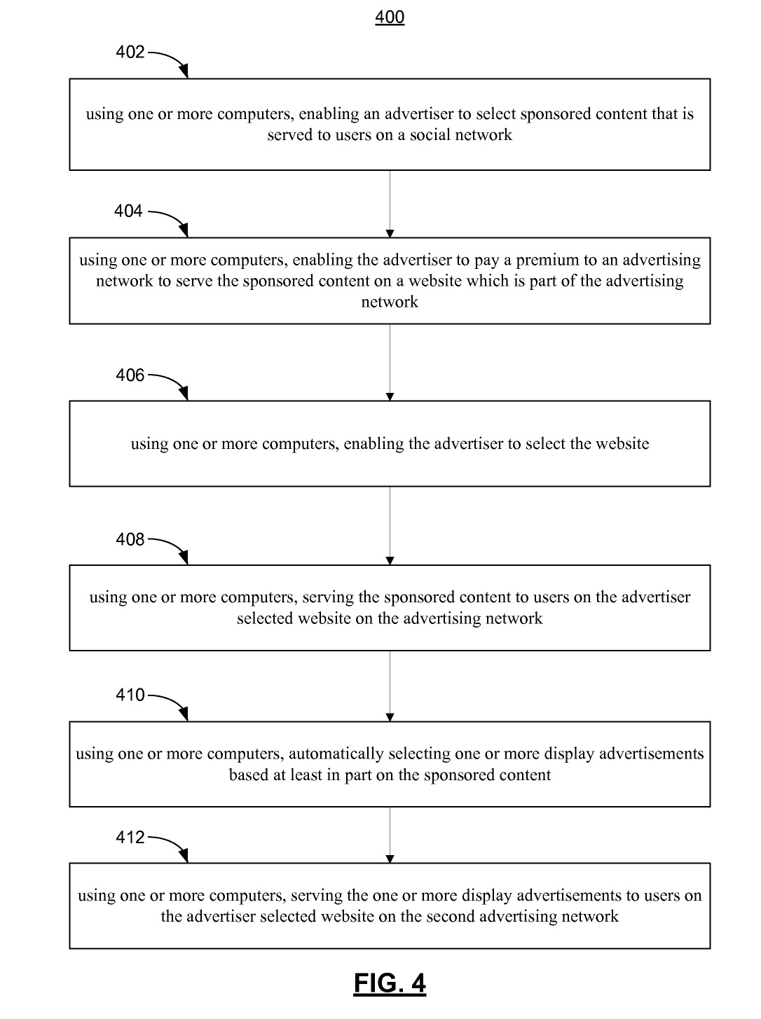

FIG. 4 is a flowchart diagram illustrating a method 400 according to one embodiment of the invention. At step 402, using one or more computers, an advertiser may be enabled to select sponsored content that is served to users on a social network. As used herein, sponsored content refers to, for example a sponsored story or post on Facebook®, a promoted Tweet® on Twitter®, etc. In one embodiment, an interface may be displayed to enable the advertiser to select the sponsored content.

At step 404, using one or more computers, the advertiser may be enabled to pay a premium to an advertising network to serve the sponsored content on a website which is part of the advertising network. For example, an advertiser may pay a premium to Yahoo for serving sponsored content from the social network, such as Facebook or Twitter on one of Yahoo's websites or portals. In one embodiment, an interface may be displayed to enable the advertiser to provide payment to the advertising network. Alternatively, or in addition to paying a premium to the advertising network, the advertiser may pay a premium to the social network in order to be able to display the sponsored content on the advertising network.

At step 406, using one or more computers, the advertiser may be enabled to select the website on which the advertiser would like the sponsored content to be displayed. For example, the advertiser may wish to display the sponsored content only on fashion related websites. In one embodiment, an interface may be displayed to enable the advertiser to select or specify one or more websites on which the advertiser would like the sponsored content to be displayed. In one embodiment, the advertiser may specify one or more criteria relating to the website(s) on which they would like the sponsored content to be displayed. For example, the advertiser may specify that the sponsored content should be displayed on websites including fashion related content or sports related content. As will be apparent to one of ordinary skill in the art, the advertiser may specify any number of behavioral, demographic, or keyword targeting criteria relating to their target audience.

At step 408, using one or more computers, the sponsored content may be served to users on the advertiser selected website on the advertising network. Using the above example, the sponsored content may be served to users viewing Yahoo's fashion related websites. In one embodiment, the sponsored content may be transmitted from one or more server computers to a user's browser application for display in the browser application.

At step 410, using one or more computers, one or more display advertisements may be automatically selected based at least in part on the sponsored content. For example, one or more display advertisements, which are related to the sponsored content may be selected. In one embodiment, the selected display advertisement(s) may be from the same advertiser as the sponsored content. For example, a display advertisement from Toyota may be selected to be displayed along with a promoted Tweet if the promoted Tweet is also from Toyota. In other embodiments, the display advertisement may be selected based on any other criteria related to the sponsored content. In one embodiment, the display advertisement(s) may be selected by the advertising network. An advertiser may specify if the advertiser would like the advertising network to select one or more advertisements to be displayed along with the sponsored content. In other embodiments, the advertiser may select one or more advertisements to be displayed along with the sponsored content.

At step 412, using one or more computers, the one or more display advertisements may be served to users on the advertiser selected website on the advertising network. In one embodiment, the one or more display advertisements may be transmitted from one or more server computers to a user's browser application for display in the browser application.

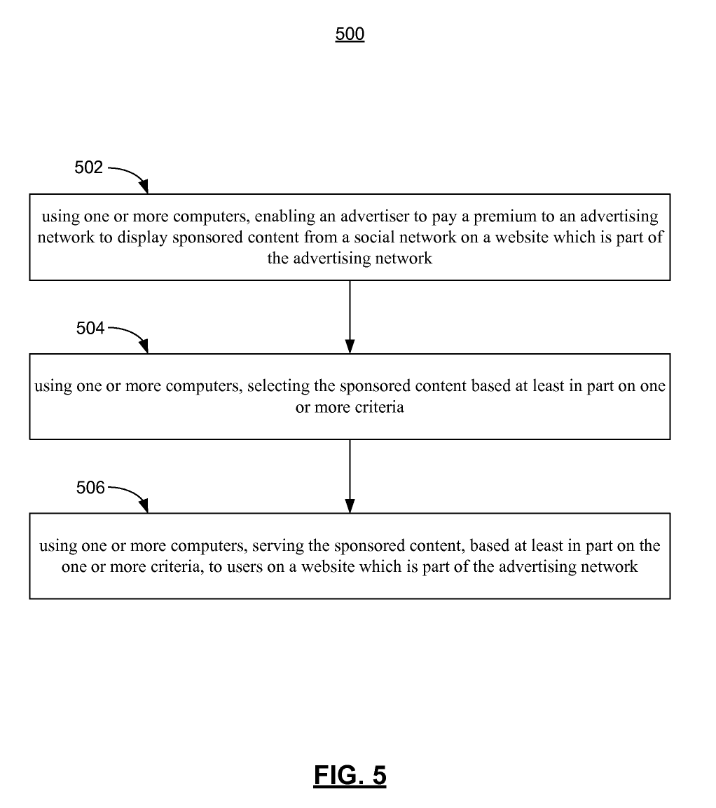

FIG. 5 is a flowchart diagram illustrating a method 500 according to one embodiment of the invention. At step 502, using one or more computers, an advertiser may be enabled to pay a premium to an advertising network to display sponsored content from a social network on a website which is part of the advertising network. As used herein, sponsored content refers to, for example a sponsored story or post on Facebook®, a promoted Tweet® on Twitter®, etc. For example, an advertiser may pay a premium to Yahoo for serving sponsored content from the social network, such as Facebook or Twitter on one of Yahoo's websites or portals. In one embodiment, an interface may be displayed to enable the advertiser to provide payment to the advertising network. Alternatively, or in addition to paying a premium to the advertising network, the advertiser may pay a premium to the social network in order to be able to display the sponsored content on the advertising network.

At step 504, using one or more computers, the sponsored content may be selected based at least in part on one or more criteria. The criteria may or may not be specified by the advertiser. In one embodiment, the sponsored content may be selected automatically based on complex logic or optimization. For example, the sponsored content may be selected based on the number of views it has on the social network, or based on the amount of time it has been “live” on the social network, etc. In another embodiment, the advertiser may specify, for example targeting criteria. In addition, in one embodiment, the advertiser may specify one or more criteria relating to the website(s) on which they would like the sponsored content to be displayed. For example, the advertiser may specify that the sponsored content should be displayed on websites including fashion related content or sports related content. As will be apparent to one of ordinary skill in the art, the advertiser may specify any number of behavioral, demographic, or keyword targeting criteria relating to their target audience.

At step 506, using one or more computers, the sponsored content may be served, based at least in part on the one or more criteria, to users on a website which is part of the advertising network. Using the above example, the sponsored content may be served to users viewing Yahoo's fashion related websites. In one embodiment, the sponsored content may be transmitted from one or more server computers to a user's browser application for display in the browser application. In one example, Ford promotes a Tweet on Twitter. Once the @Ford account has an active promoted Tweet (stories are promoted for only a limited period of time, number of views, etc.) that Tweet is automatically selected to be displayed on Yahoo sites. Ford then promotes a second Tweet, this one to specific metropolitan areas. That second promoted Tweet is selected to be displayed on Yahoo sites, but only for users in the matching region. All other users on Yahoo sites see the first promoted Tweet. Once both promoted Tweets expire, a mini-version of the @Ford profile could be displayed in ad placements on Yahoo sites, or the system could revert to showing traditional ads.

In some embodiments, the sponsored content may be served to users on a website of the advertising network based on one or more criteria. The criteria may include any number of targeting or other criteria. For example, promoted Facebook stories may be served to users who are determined to be signed in to Facebook, Twitter stories may be served to users who are predicted to be more likely to respond to a promoted Tweet, etc.

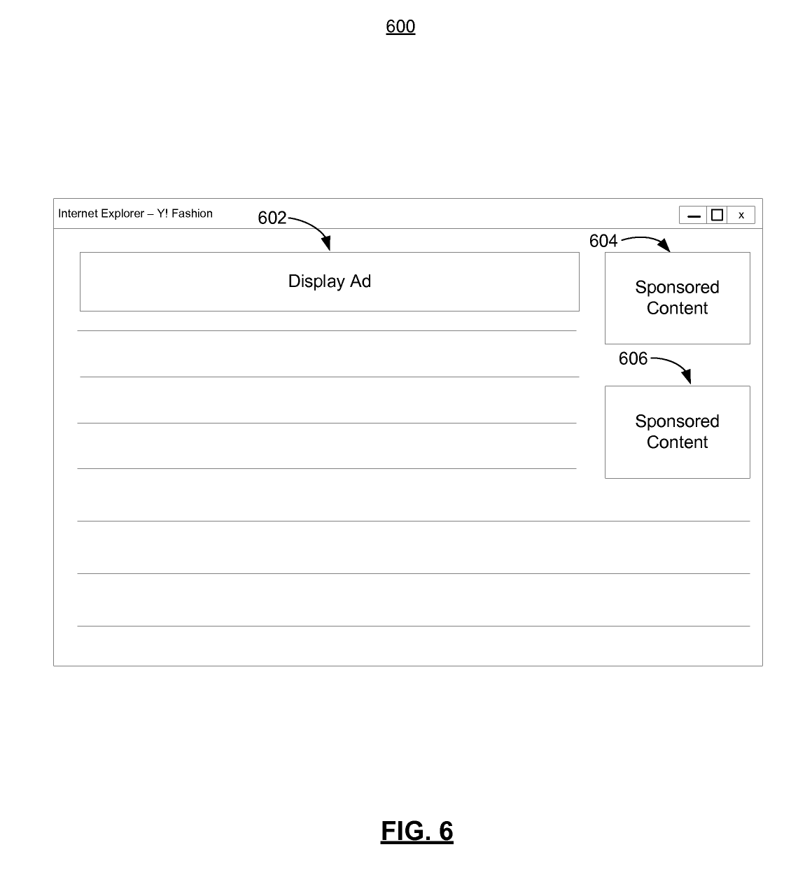

FIG. 6 illustrates a screenshot diagram 600 of a browser application according to one embodiment of the invention. Screenshot diagram 600 corresponds to a website displayed by a browser application. Embodiments of the invention allow advertisers to purchase sponsored content from a third party network such as a social network (e.g., Facebook®, Twitter®, etc.) and have that content be displayed as an advertisement on an a website on a different network, such as Yahoo®. The sponsored content may be for example, a sponsored story or post on Facebook®, or a promoted Tweet® on Twitter®. Embodiments of the invention advantageously allow advertisers to re-use content without having to spend resources having to create content for different networks. In addition, embodiments of the invention increase the amount of advertising inventory available to the third party networks (e.g., social networks). Some embodiments, of the invention allow advertisers to update, or change the content, and have the updated or changed content be pushed to websites on the advertising network in real time.

As shown in FIG. 6, an exemplary website is displayed in a browser application in screenshot 600. The website may be displayed in a browser application on for example, any one or more of client devices 101-104 (FIG. 1). The website includes sponsored content 604 and 606 and at least one display advertisement 602. Sponsored content 604 and/or 606 may include for example, a sponsored story or post on Facebook®, a promoted Tweet® on Twitter®, etc. In one embodiment, the advertiser may specify one or more criteria relating to the website(s) on which they would like the sponsored content to be displayed. For example, the advertiser may specify that the sponsored content should be displayed on websites including fashion related content or sports related content. As will be apparent to one of ordinary skill in the art, the advertiser may specify any number of behavioral or demographic targeting criteria relating to their target audience.

In one embodiment, display advertisement 602 may be selected based at least in part on the sponsored content. For example, display advertisement(s) may be from the same advertiser as the sponsored content. For example, a display advertisement from Toyota may be selected to be displayed along with a promoted Tweet if the promoted Tweet is also from Toyota. In other embodiments, the display advertisement may be selected based on any other criteria related to the sponsored content. In one embodiment, the display advertisement(s) may be selected by the advertising network. An advertiser may specify if the advertiser would like the advertising network to select one or more advertisements to be displayed along with the sponsored content. In other embodiments, the advertiser may select one or more advertisements to be displayed along with the sponsored content. Although only one display advertisement 602 is shown, multiple display advertisements may be displayed on the website. In addition, although two items of sponsored content are shown, one or more items of sponsored content may be displayed on the website. Moreover, the positioning of the display advertisement and the sponsored content shown in FIG. 6 is not limited to the illustrated example. The display advertisement(s) and the sponsored content may be displayed anywhere on the website.

It will be understood that each block of a flowchart illustration need not be limited in the ordering shown in the illustration, and might be performed in any ordering, or even performed concurrently, without departing from the spirit of the invention. It will also be understood that each block of the flowchart illustration, and combinations of blocks in the flowchart illustration, can be implemented by computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

1. A method comprising:
using one or more computers, enabling an advertiser to select sponsored content that is served to users on a social network;
using one or more computers, enabling the advertiser to pay a premium to an advertising network to serve the sponsored content on a website which is part of the advertising network;
using one or more computers, enabling the advertiser to select the website; and
using one or more computers, serving the sponsored content to users on the advertiser selected website on the advertising network.

2. The method of claim 1, further comprising:
using one or more computers, enabling the advertiser to update the sponsored content;
using one or more computers, pushing the updated sponsored content to the website substantially in real-time.

3. The method of claim 1, wherein the advertising network comprises a plurality of websites.

4. The method of claim 1, further comprising:
using one or more computers, enabling the advertiser to select one or more display advertisements.

5. The method of claim 4, further comprising:
using one or more computers, serving the one or more display advertisements to users on the advertiser selected website on the advertising network.

6. The method of claim 5, wherein the one or more display advertisements are displayed adjacent to the sponsored content.

7. The method of claim 1, further comprising:
using one or more computers, automatically selecting one or more display advertisements based at least in part on the sponsored content.

8. The method of claim 7, further comprising:
using one or more computers, serving the one or more display advertisements to users on the advertiser selected website on the advertising network.

9. The method of claim 8, wherein the one or more display advertisements are displayed adjacent to the sponsored content.

10. The method of claim 1, further comprising:
using one or more computers, enabling the advertiser to pay a premium to the social network to select the sponsored content.

11. A system comprising:
one or more server computers coupled to a network;
wherein the one or more server computers are for:
enabling an advertiser to select sponsored content that is served to users on a social network;
enabling the advertiser to pay a premium to an advertising network to serve the sponsored content on a website which is part of the advertising network;
enabling the advertiser to select the website; and
serving the sponsored content to users on the advertiser selected website on the advertising network.

12. The system of claim 11, wherein the one or more server computers are further configured for:
enabling the advertiser to update the sponsored content;
pushing the updated sponsored content to the website substantially in real-time.

13. The system of claim 11, wherein the advertising network comprises a plurality of websites.

14. The system of claim 11, wherein the one or more server computers are further configured for:
enabling the advertiser to select one or more display advertisements.

15. The system of claim 14, wherein the one or more server computers are further configured for:
serving the one or more display advertisements to users on the advertiser selected website on the advertising network.

16. The system of claim 15, wherein the one or more display advertisements are displayed adjacent to the sponsored content.

17. The system of claim 11, wherein the one or more server computers are further configured for:
automatically selecting one or more display advertisements based at least in part on the sponsored content.

18. The system of claim 17, wherein the one or more server computers are further configured for:
serving the one or more display advertisements to users on the advertiser selected website on the advertising network.

19. The system of claim 18, wherein the one or more display advertisements are displayed adjacent to the sponsored content.

20. A non-transitory computer readable medium having stored thereon instructions for causing a computer to execute a method, the method comprising:
enabling an advertiser to select sponsored content that is served to users on a social network;
enabling the advertiser to pay a premium to an advertising network to serve the sponsored content on a website which is part of the advertising network;
enabling the advertiser to select the website;
serving the sponsored content to users on the advertiser selected website on the advertising network;
automatically selecting one or more display advertisements based at least in part on the sponsored content; and
serving the one or more display advertisements to users on the advertiser selected website on the advertising network.
